(19) United States
(12) Patent Application Publication
(10) Pub. No.: US 2008/0136369 A1
(43) Pub. Date: Jun. 12, 2008

(54) Charging device for hearing aid

(76) Inventors: Harald Klemenz, Singapore (SG); Thomas Lotter, Nurnberg (DE); Herve Schulz, Erlangen (DE); Roland Weigert, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/983,341

(22) Filed: Nov. 8, 2007

(30) Foreign Application Priority Data
Aug. 11, 2006 (DE) 102006052713.5

(51) Int. Cl. H02J 7/00; H04R 25/00

(52) U.S. Cl. 320/107

(57) ABSTRACT

The invention relates to a charging device for a battery-powered hearing aid, with said charging device having a housing with a cover and a holder for the hearing aid, with a contact element of a hearing aid being pressed, by a preload, against a charging contact of the charging device during charging, characterized in that the cover includes the charging contact.

### CROSS REFERENCE TO RELATED APPLICATIONS

This application claims priority of German application No. 102006052713.5 DE filed Nov. 8, 2006, which is incorporated by reference herein in its entirety.

### FIELD OF INVENTION

The invention relates to a charging device for a battery-powered hearing aid.

### BACKGROUND OF INVENTION

Due to the development of more efficient rechargeable batteries, it is possible for hearing aids to be fitted with, and operated by, batteries. This presents the problem that the battery has to be recharged at periodic intervals, which usually takes place in a charging device. To do this, the battery is normally removed from the hearing aid and placed in the charging device. Because hearing aids, especially in-the-ear (ITE) devices are extremely small, it is difficult to remove the battery from the hearing aid. This applies particularly to older hearing aid wearers. For this reason, hearing aids have been developed according to prior art that have a permanently fitted battery. So that the battery can be charged in the hearing aid, it is designed so that it can be charged by induction. A hearing aid of this kind with a battery that can be charged by induction is, for example, described in U.S. Pat. No. 6,498,455.

A battery that can be charged by induction is expensive to produce and requires additional space, which is always very restricted in a hearing aid. Charging by induction also requires a more expensive charging device and causes a high energy consumption.

In EP 0 630 549 B1 a charging device is described that has a holder that contains the contact pins for charging the hearing aid and is adapted to a wearer-specific shape (otoplastic) of the hearing aid. A charging device of this kind is expensive because the charging contacts are integrated into a customized component.

### SUMMARY OF INVENTION

The object of this invention is to provide a charging device that overcomes the named disadvantages of the prior art.

The object is achieved according to the invention by a charging device as claimed in independent claims. Advantageous developments of the hearing aid and of the charging device are given in the dependent claims.

The invention relates to a charging device for a battery-powered hearing aid, with said charging device having a housing with a cover and a holder for the hearing aid, with a contact element of a hearing aid being pressed, by a preload, against a charging contact during charging, characterized in that the cover contains the charging contact, i.e. the charging contact or contacts is/are provided in the cover.

In order to press the contact element of the hearing aid against the charging contact of the charging device with a preload, the charging device can, according to a further aspect of this invention, have a magnetic element by means of which pressure can be exerted against a hearing aid by magnetic force. For example, a permanent magnet or an electromagnet, which attracts a magnetic element in the hearing aid, e.g. the battery, can be provided in the charging device.

According to an alternative aspect of this invention, the contact element of the hearing aid is pressed, preloaded, against the charging contact of the hearing aid by spring pressure, with the charging element having a suitable spring element or tensioning element, e.g., a spring clip, to clamp the hearing aid.

According to a further aspect of this invention, the charging device has a holder for a hearing aid, which due to its spatial arrangement provides a defined charging position of the charging device. The holder can be adapted to the shape of the hearing aid. For this purpose, it is conceivable that the holder is matched to an area of the hearing aid specific to the wearer (this applies particularly for in-the-ear (ITE)) or the holder can be matched to an area of the hearing aid that is not specific to a wearer. The shape of the holder can be designed to be complimentary to a surface shape of the hearing aid.

According to a further aspect of this invention, an adapter element is provided, with the holder being adapted to the adapter element and the adapter element being matched to a wearer-specific area of the hearing aid. It is thus possible to provide a single type of charging device for a multiplicity of individual hearing aids shaped to suit specific wearers, and to provide each charging device with an adapter to suit the individual hearing aid.

The holder can also be provided as a completely separate component, e.g. in the form of an adapter, so that the charging device can then always be of identical construction and need only be fitted with an adapter matched to the individual hearing aid, in order to enable adaptation to the hearing aid.

According to a further aspect of this invention, correct polarity of the charging contact is provided by the charging position of the hearing aid in the holder of the charging device.

The term “battery” in the context of this invention includes any rechargeable battery, capacitor or similar that is rechargeable and can provide the hearing aid with electrical energy. The contact element can be a contact surface, a contact pin, a contact clip or any other contact suitable for receiving the charging current. “Flexibly arranged on the hearing aid” in its widest sense means moveable, flexible or deformable, so that the contact element can be pressed by a preload against a corresponding charging contact of an external charging device which acts as an abutment.

With regard to the contact element of the hearing aid, a distinction is to be made between two situations: an operating or at-rest state on the one hand in which the hearing aid is not being charged and a charging state on the other hand in which the hearing aid is being charged by the charging device. According to a preferred aspect of this invention, the contact element during an operating or at-rest state of the hearing aid is in a first position and during a charging state is in a second position. Preferably, the contact element is designed so that it returns automatically from the second position to the first position on completion of the charging operation and after removal of the hearing aid from the charging device.

A suitable opening in the housing of the hearing aid can be provided for the contact element. According to a preferred aspect of this invention, an outer surface of the contact element closes essentially flush with the surface of the housing of the hearing aid in the first position (i.e. in the operating or at-rest position). This is aesthetically attractive and pleasing to the touch and has the advantage that the ingress of cerumen to the inside of the hearing aid at this point is prevented.

According to an alternative aspect, the contact element in the second position can be lowered into a recess in the hearing aid housing. This is advantageous with a corresponding charging device that has a pin-type charging contact which can then engage in the recess of the hearing aid housing and contact the contact element.

According to one aspect, the hearing aid can also have a switch with the contact element being changed from the first to the second position and vice versa by means of the switch. According to a further aspect, the switch is actuated by bringing the hearing aid into contact with the external charging device, e.g. when the hearing aid is placed in the holder provided for it in the charging device.

In the second position (i.e. during a charging state), the contact element of the hearing aid can project out from the hearing aid housing. The contact element can, for example, be designed as a pin that can be moveably mounted on the hearing aid so that in the second position it can be pushed through an opening in the hearing aid housing and project out of the housing. In this state, the contact element can then be contacted without difficulty by the charging contact of the charging device.

### BRIEF DESCRIPTION OF THE DRAWINGS

Further features and advantages of this invention are clearly explained using exemplary embodiments and the attached illustrations. The illustrations are as follows:

FIG. 1 A schematic representation of a hearing aid and associated charging device;

FIG. 2 A schematic representation of a further hearing aid and associated charging device;

FIG. 3 A schematic representation of a further hearing aid and associated charging device;

FIG. 4 A schematic representation of a further hearing aid and associated charging device;

FIG. 5 A schematic representation of a further hearing aid and associated charging device;

FIG. 6 A schematic representation of a further hearing aid and associated charging device;

FIG. 7 A schematic representation of an embodiment of a hearing aid and associated charging device.

### DETAILED DESCRIPTION OF INVENTION

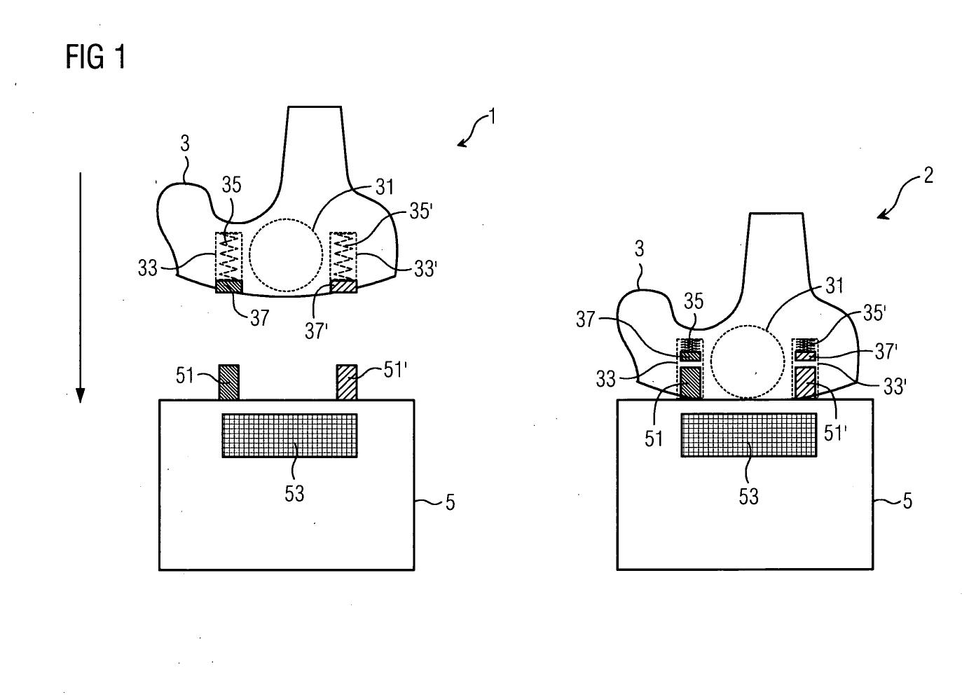

FIG. 1 shows a hearing aid 3 and associated charging device 5 in a first position 1 and a second position 2. The hearing aid 3 is an in-the-ear (ITE) hearing aid and it contains a battery 31. Two openings with guides 33 and 33′ are provided in the housing of said hearing aid 3. Reset elements 35 and 35′ in the form of coil springs, on the ends of which are contact elements 37 and 37′, are located in the guides. The contact elements 37, 37′ are moveably fitted in the guides 33, 33′ and in the first position (i.e. in an operating or at-rest state of the hearing aid without interaction with the charging device) are in a position in which the outer surface of the contact elements 37, 37′ is essentially flush with the housing of the hearing aid 3, so that the openings are covered by the contact elements. This advantageously prevents cerumen or dirt entering the hearing aid. The charging device 5 has two charging contacts 51 and 51′ in the form of pins and contains a magnet 53.

In a second position 2, i.e. during a charging operation, the hearing aid is brought into contact with the charging device. The magnet 53 attracts the battery 31 and thus holds the hearing aid 3 on the charging contacts 51, 51′, designed as pins. The charging contacts are in electrical contact with the contact elements 37, 37′ of the hearing aid, with the contact elements 37, 37′ being lowered into the guides 33, 33′ and the resetting elements 35 and 35, in the form of coiled springs, being compressed. Due to the magnetic force of the magnet 53 on the one hand and the spring force of the resetting elements 35, 35′ on the other, the contact elements 37, 37′ are pressed under a preload against the charging contacts 51, 51′ of the charging device.

Because the charging contacts 51, 51′, designed as pins, plug into the guides 33, 33′, a good retention of the hearing aid against the charging device is guaranteed. To prevent incorrect polarity of the contacts, both charging contacts of the charging device and the associated housing opening or guides 33, 33′ should be of different size or of different shape, so as to allow only one alignment. It is also conceivable that the charging device has a holder with a shape that is complimentary to the hearing device (not illustrated).

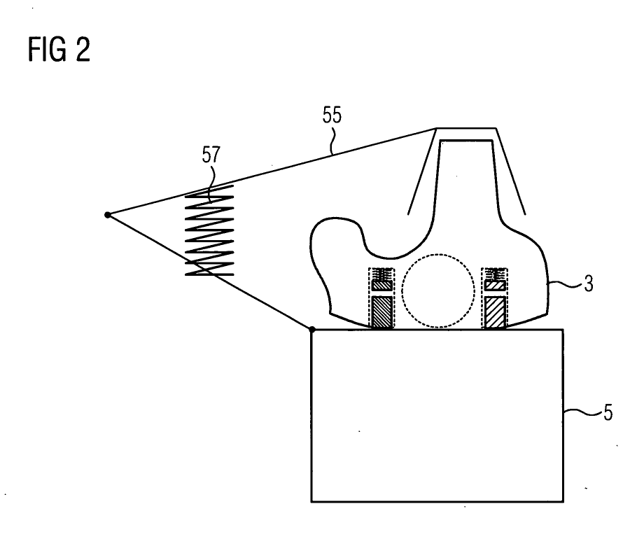

The hearing aid 3 shown in FIG. 2 is of an identical embodiment to the hearing aid in FIG. 1. The charging device 5, however, does not have a magnet but instead has a spring clip 55 pressed together by a spring 57 so that the hearing aid 3 can be clamped between the spring clip 55 and the charging device 5. It is pointed out that the illustration of the spring clip 55 is schematic and very simplified.

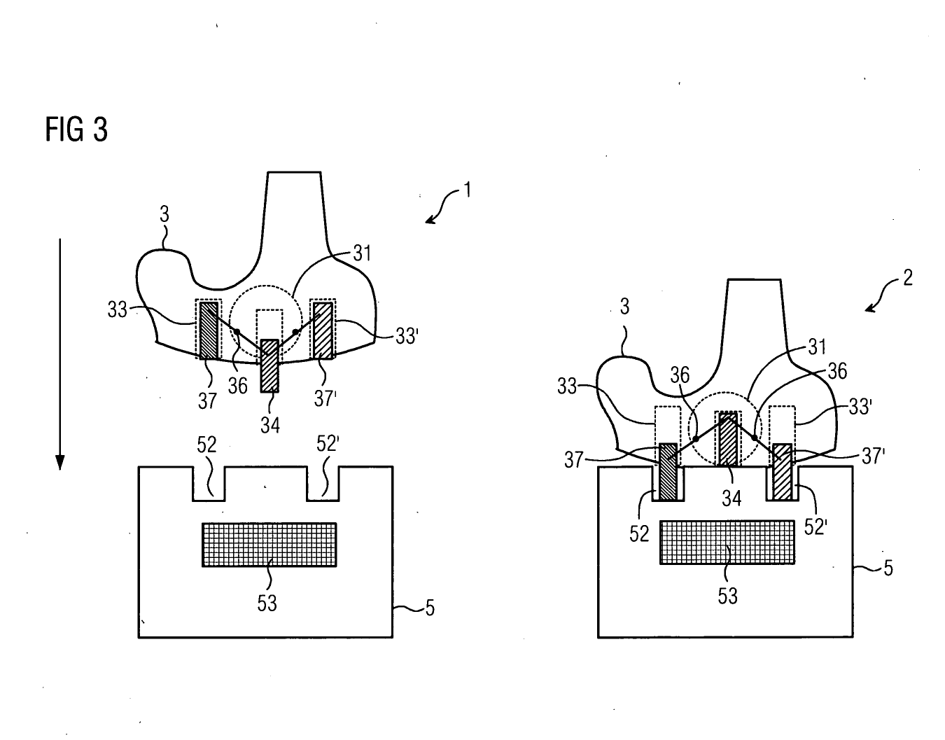

FIG. 3 shows a further embodiment of the hearing aid 3 and associated charging device 5. The hearing aid 3 is shown in a first position 1 (i.e. in a charging or at-rest state) and in a second position 2 (i.e., in a charging state). The hearing aid 3 has a slide switch 34 that is connected by an actuator 36 to the contact elements 37, 37′, in the form of contact pins, with said contact elements 37, 37′ moving in the guide 33, 33′. A magnet 53, which in a charging position 2 attracts the hearing aid (or the battery (31), is provided in the charging device 5. Due to this arrangement, the switch 34 is actuated and the contact elements 37, 37′ are pushed out of the guides 33, 33′ by means of the actuator 36, so that they project out of the hearing aid housing. In the second position 2, the contact elements 37, in the form of contact pins, of the hearing aid 3 are received by the charging contacts 52, 52′, in the form of sockets, of the charging device 5.

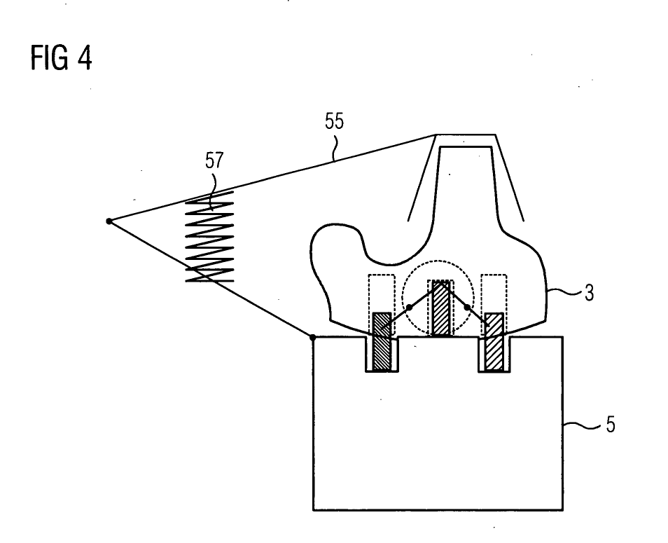

FIG. 4 shows an alternative embodiment of the charging device 5, with the hearing aid 3 being identical to the embodiment of the hearing aid shown in FIG. 3. The charging device 5 shown in FIG. 4 has a spring clip 55, as already described with reference to FIG. 2, which is compressed by a spring 57 so that the hearing aid 3 can be clamped between the charging device 5 and the spring clip 57.

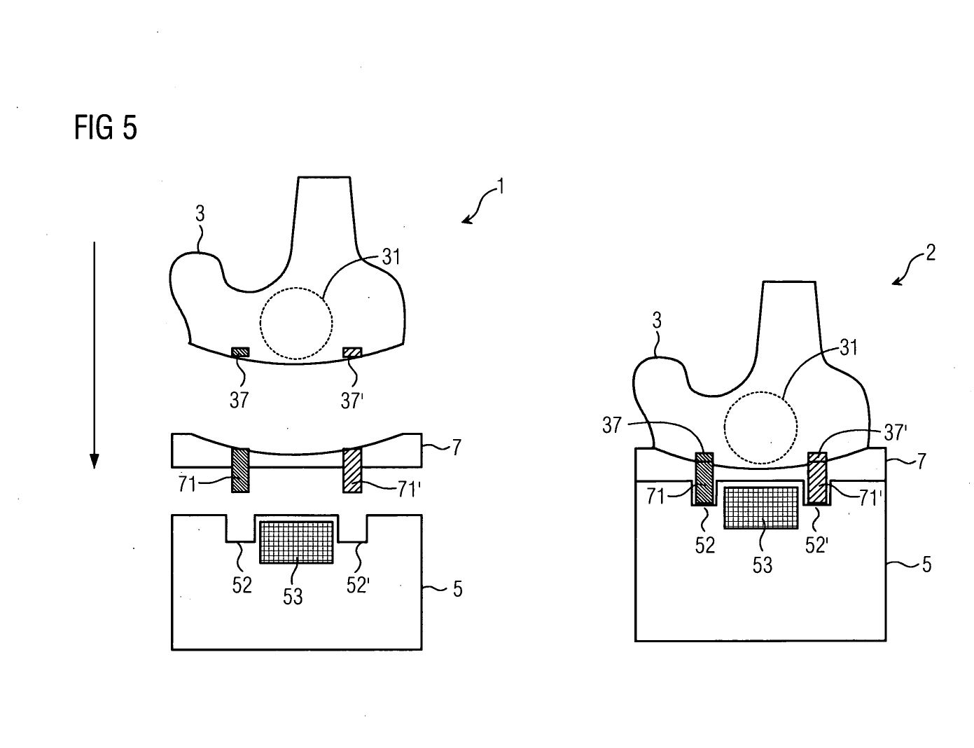

FIG. 5 shows a further embodiment of a hearing aid 3 and a charging device 5, with the charging device 5 having a holder for an adapter 7 which is matched to the hearing aid 3. The hearing aid 3, the adapter 7 and the charging device 5 are shown in a first position 1 and in a second position 2 (charging position). The charging device 5 has charging contacts 52, 52′, in the form of charging sockets, which can receive the corresponding contact pins 71, 71′ of the adapter 7. In the charging position 2, the contact pins 71, 71′ of the adapter 7 are in electrical contact with the contact elements 37, 37′ of the hearing aid 3. The battery 31 of the hearing aid 3 is attracted by a magnet 53 in the charging device, so that the contact elements 37, 37′ are pressed, preloaded, over the contact pins 71, 71′ of the adapter 7 onto the charging contacts 52, 52′ of the charging device 5.

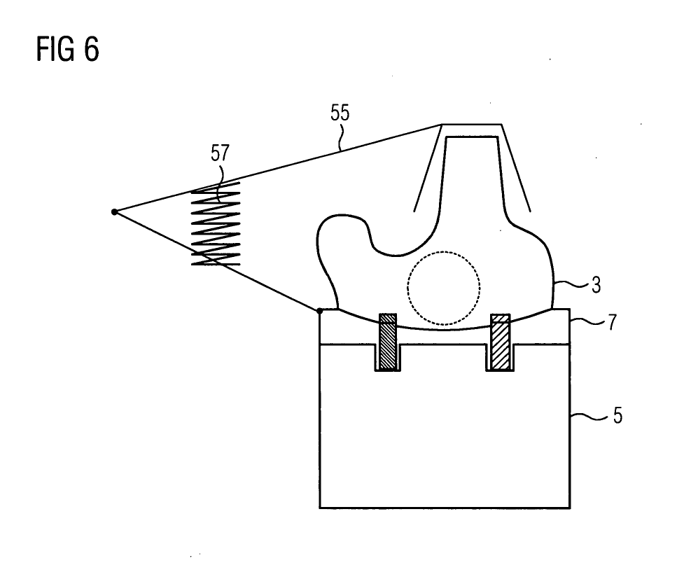

In FIG. 6 an alternative embodiment is shown where the arrangement, as described above in conjunction with FIGS. 2 and 4, has a spring clip 55 which can be compressed by a spring 57 so that the hearing aid 3 can be clamped between the adapter 7 and the spring clip 55.

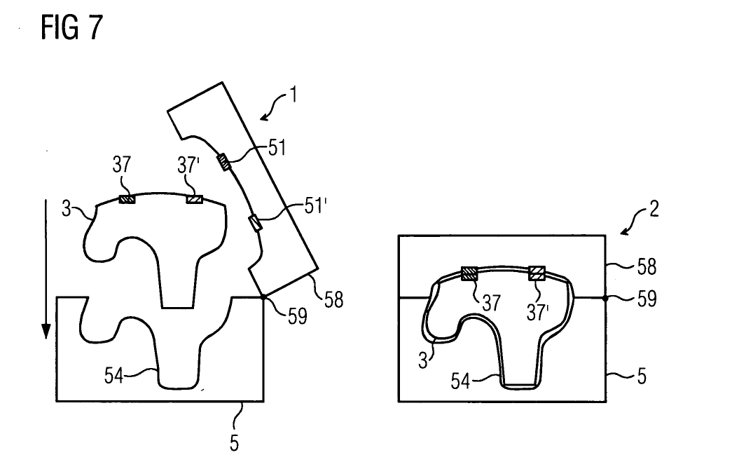

FIG. 7 shows a hearing aid 3 with an inventive embodiment of a charging device 5 in a first position 1 and a second position 2 (charging position). The charging device 5 has a holder 54 adapted to the hearing aid 3, in which the hearing aid 3 can be received. A flap, or cover, 58 contains the charging contacts 52, 51′ at the charging device end, which in the charging position 2 are in electrical contact with the contact elements 37, 37′ of the hearing aid 3. The flap 58 is moveably linked to the main part of the charging device 5 by means of a hinge 59. The flap 58 can have a closure element (not illustrated), e.g. a snap closure or a magnetic closure, so that the hearing aid 3 can be clamped in the closed charging device 5 and the contact elements 37, 37′ of the charging device pressed, under preload, against the charging contacts 51, 51′ of the charging device.

The holder 54 can be provided as a separate component (not illustrated), e.g. in the form of an adapter, so that the charging device can always be of identical construction and, to enable adaptation to the hearing aid, need only be fitted with an adapter matched to the individual hearing aid.

It is provided that the inventive hearing aid and associated charging device can be provided both as an in-the-ear (ITE) and also as a behind-the-ear (BTE) hearing aid. The charging device can also have a display device, e.g. an LED that indicates the charging status of the hearing aid. It is conceivable that the contact elements of the hearing aid be provided in an earpiece opening and/or microphone opening of the hearing aid. Furthermore, the earpiece opening and/or microphone opening can in principle, or in addition to the aforementioned possibilities, be used to align the hearing aid on the charging device, i.e. in that the pins engage in these openings. To switch the hearing aid to a charging operating state during a charging operation, the operating current could be set to a specific level when the hearing aid is inserted over the charging contacts, thus activating a charging mode. It is also conceivable that after successful charging and removal from the charging device the hearing aid can be switched on again by remote control.

The illustrated exemplary embodiments are merely for illustration and serve as examples. With regard to the arrangement of the hearing aid, charging device and corresponding contact elements and charging contacts, changes and variation are possible within the framework of the scope defined by the patent claims.

1.-7. (canceled)

8. A charging device for a battery-powered hearing aid, comprising:
a housing with a cover; and
a charging contact included on the cover to charge the battery when a contact element of the hearing aid is pressed against the charging contact.

9. The charging device as claimed in claim 8, further comprising a magnetic element to apply a magnetic force between the charging contact and contact element of the hearing aid being pressed by magnetic force.

10. The charging device as claimed in claim 8, wherein the contact element of the hearing aid being pressed by spring force, under preload, against the charging contact of the charging device.

11. The charging device as claimed in one of claims 8, wherein a defined loading position of the hearing aid is provided by the spatial arrangement of a holder for the hearing aid.

12. The charging device as claimed in claim 11, wherein the holder is adapted to a wearer-specific area of the hearing aid.

13. The charging device as claimed in claim 12, wherein the holder is adapted to an adapter element that is matched to a wearer-specific area of the hearing aid.

14. The charging device as claimed in one of claims 11, wherein the position of the hearing aid in the holder is defined by a correct polarity of the charging contact.

15. A charging device for a battery-powered hearing aid, comprising:
a housing with a cover; and
a charging contact included on the cover to contact an adapter element designed to match a wear-specific area of the hearing aid and designed to couple the hearing aid to the charging device in order to charge the battery.

16. The charging device as claimed in claim 16, further comprising a magnetic element to apply a magnetic force between the adapter element and the charging device.

17. The charging device as claimed in claim 16, further comprising a magnetic element to apply a magnetic force between the hearing aid and the charging device.
